(19) United States
(12) Patent Application Publication
(10) Pub. No.: US 2015/0349514 A1
(43) Pub. Date: Dec. 3, 2015

(54) MULTIFUNCTIONAL ELECTRICAL POWER OUTPUT PROTECTION DEVICE

(71) Applicant: ZONESKING TECHNOLOGY CO., LTD., New Taipei CIty (TW)

(72) Inventors: Li-Bang Chen, New Taipei City (TW); Jia-Yi Wu, New Taipei City (TW); Tzu-Yu Yang, New Taipei City (TW); Li-Chuan Chen, New Taipei City (TW); Kuo-Wen Kao, New Taipei City (TW)

(73) Assignee: ZONESKING TECHNOLOGY CO., LTD., New Taipei CIty (TW)

(21) Appl. No.: 14/287,198

(22) Filed: May 27, 2014

(51) Int. Cl. H02H 3/20; H02H 11/00

(52) U.S. Cl. CPC H02H 3/20; H02H 11/003

(57) ABSTRACT

A multifunctional electrical power output protection device includes a protection device having a circuit board. The circuit board is mounted in a receiving space of the protection device and includes an input port, an output port, a switching element, a detection element, and a manually-operating overriding device. The manually-operating overriding device is electrically connected to an end of the detection element. The switching element has an end electrically connected to the input port and an opposite end electrically connected to the output port. The detection element has an end electrically connected to the input port and an opposite end electrically connected to the output port. The switching element and the detection element that are connectable to an external power supply respectively provide an effect of preventing backward charging induced by a reverse electrical current and effects of over-loading interruption and current-limiting protection.

### (a) TECHNICAL FIELD OF THE INVENTION

The present invention generally relates to a multifunctional electrical power output protection device, and more particularly to a device comprising a circuit board comprising a switching element and a detection element mounted thereon to be connected by a user to an external power supply device for charging an external load, wherein the switching element provides an effect of preventing a reverse electrical current from backward charging and the detection element provides effects of over-loading interruption and current limiting protection so as to achieve the purpose of multifunctional electrical power output protection.

### (b) DESCRIPTION OF THE PRIOR ART

Heretofore, to supply electrical power to an external load or to charge a battery 92, as shown in FIG. 1, an electrical power output device 90 or a charger is electrically connected through a charging cable 91 to the load or the battery 92 for performing immediate charging and thus achieving the purpose of electrical charging of the load or the battery 92.

Although the conventional electrical power output device 90 is effective to achieve immediate charging, when the electrical power output device 90 is put into electrical connection with the load or the battery 92, a large amount of electrical current is generated from the electrical power output device 90 for charging the load or the battery 92. It is thus very likely that the electrical power output device 90 may generate an excessively large electrical current for instantaneous output of power so as to lead to an excessively high temperature of the load or the battery 92 and a potential risk of explosion. Further, when the electrical power output device 90 is charging the load or the battery 92, it is also likely that a reverse electrical current is induced, flowing back to the electrical power output device 90 so as to lead to damage or burn out of the electrical power output device 90.

The technical issue that the present invention aims to address is to overcome the above-discussed problems.

### SUMMARY OF THE INVENTION

In view of the problem that the conventional electrical power output device has the drawback of generating an excessively large instantaneous electrical current for power output, which leads to a potential risk of an excessively high temperature and thus explosion of a load or a battery and suffering easy damage or burn-out of the electrical power output device, the present invention aims to provide a multifunctional electrical power output protection device, which comprises a circuit board comprising a switching element and a detection element mounted thereon to be connected by a user to an external power supply device for charging an external load, wherein the switching element provides an effect of preventing a reverse electrical current from backward charging and the detection element provides effects of over-loading interruption and current limiting protection so as to achieve the purpose of multifunctional electrical power output protection.

The primary object of the present invention is to provide a multifunctional electrical power output protection device, which comprises:

a protection device, wherein the protection device comprises a circuit board and the circuit board is mounted in a receiving space of the protection device, the circuit board comprising an input port, an output port, a switching element, a detection element, and a manually-operating overriding device, the manually-operating overriding device being electrically connected to an end of the detection element, the switching element having an end electrically connected to the input port, the switching element having an opposite end electrically connected to the output port, the detection element having an end electrically connected to the input port, the detection element having an opposite end electrically connected to the output port.

The multifunctional electrical power output protection device according to the present invention is arranged such that a user may connect the switching element and the detection element of the circuit board to an external power supply device in order to charge an external load, whereby the switching element provides an effect of preventing a reverse electrical current from backward charging and the detection element provides effects of over-loading interruption and current limiting protection so as to achieve the purpose of multifunctional electrical power output protection.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the connection of a conventional device.

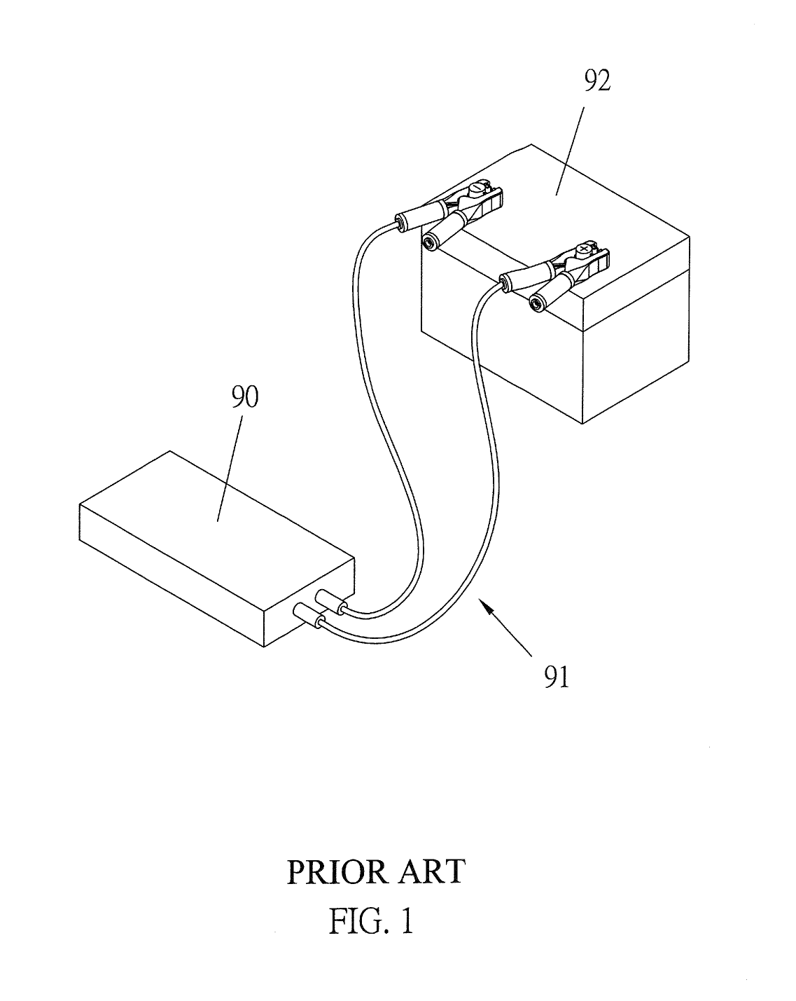

FIG. 2 is a block diagram showing the present invention.

FIG. 3 is a perspective view of the present invention.

FIG. 4 is a block diagram showing the use of the present invention with a power supply device and a load.

FIG. 5 is a block diagram of the present invention showing a switching element is switched on.

FIG. 6 is a block diagram of the present invention showing a manually-operating overriding device is actuated.

FIG. 7 is a flow chart illustrating a process that a detection element of the present invention detects a voltage of a Vₒ terminal.

FIG. 8 is a flow chart illustrating a process that the detection element of the present invention detects if the voltage of the Vₒ terminal is greater than a voltage of a Vᵢ terminal.

FIG. 9 is a flow chart illustrating a process that the detection element of the present invention detects if the voltage of the Vᵢ terminal is greater than the voltage of the Vₒ terminal.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

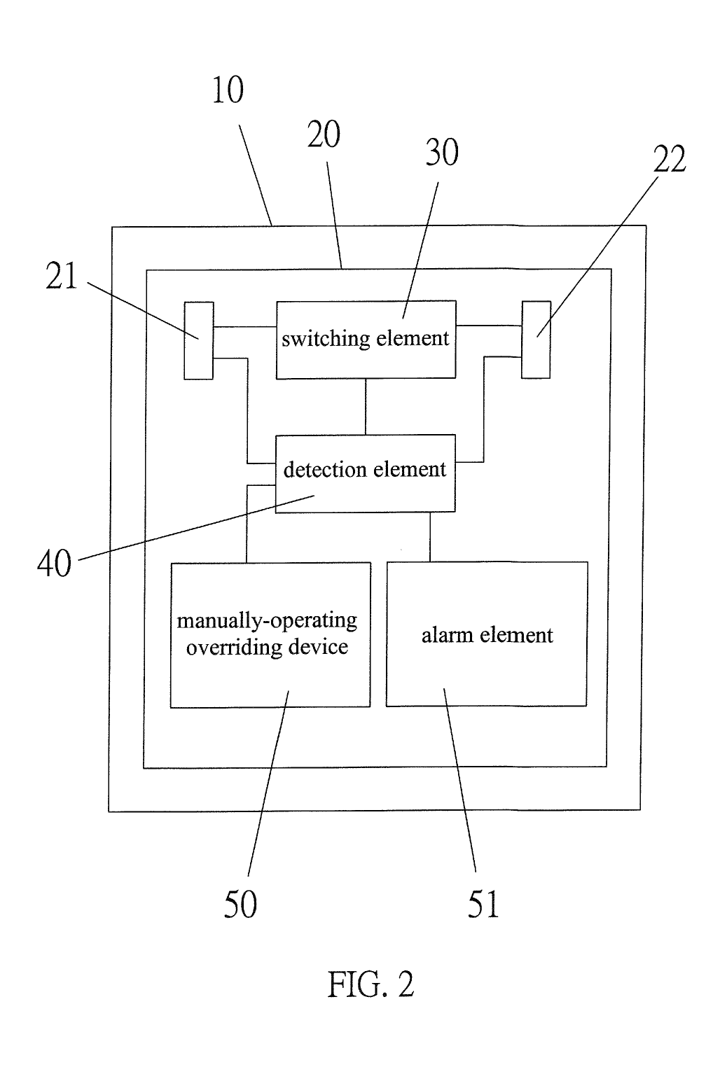

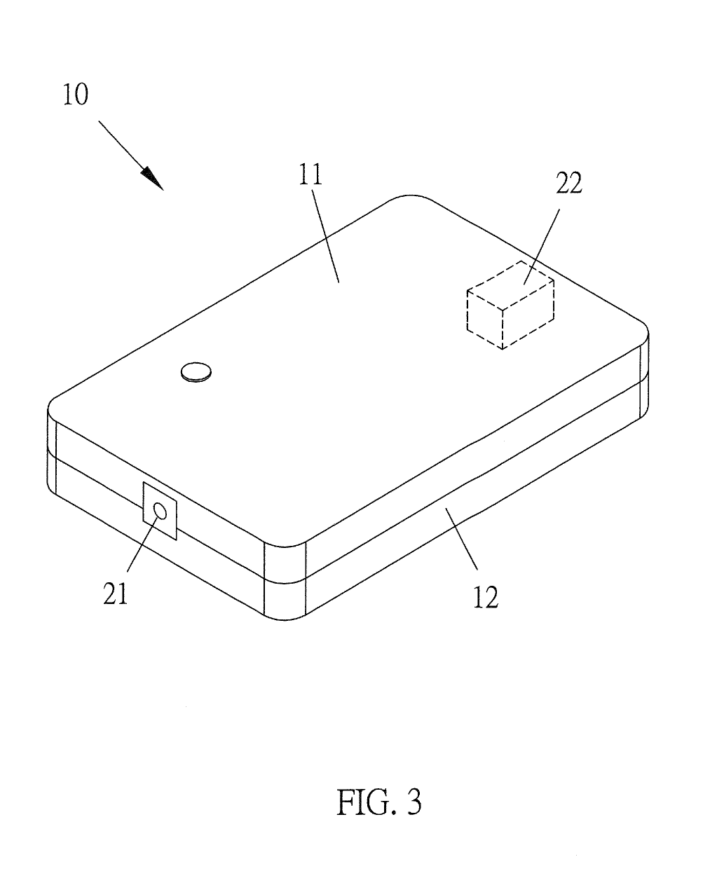

Referring to FIGS. 2 and 3, the primary object of the present invention is to provide a multifunctional electrical power output protection device, which comprises:

a protection device 10, wherein the protection device 10 comprises a circuit board 20 mounted therein and the circuit board 20 comprises an input port 21, an output port 22, a switching element 30, a detection element 40, and a manually-operating overriding device 50, the manually-operating overriding device 50 being electrically connected to an end of the detection element 40, the switching element 30 having an end electrically connected to the input port 21, the switching element 30 having an opposite end electrically connected to the output port 22, the detection element 40 having an end electrically connected to the input port 21, the detection element 40 having an opposite end electrically connected to the output port 22, the switching element 30 being in an initially condition of an OFF state, which is open-circuited and is not conducting, the switching element 30 being a device of a semiconductor manufacturing process or an electro-mechanical device, the switching element 30 being an FET (Field Effect Transistor), or an MOSFET (Metal Oxide Semiconductor Field Effect Transistor), or a JFET (Junction Gate Field Effect Transistor), or a relay, the detection element 40 being an MCU (Microcontroller Unit), or a comparator, or an amplifier, the circuit board 20 comprising an alarm element 51 mounted thereon, the alarm element 51 being electrically connected to the detection element 40, the alarm element 51 being a buzzer, or a light-emitting element, or a liquid crystal display.

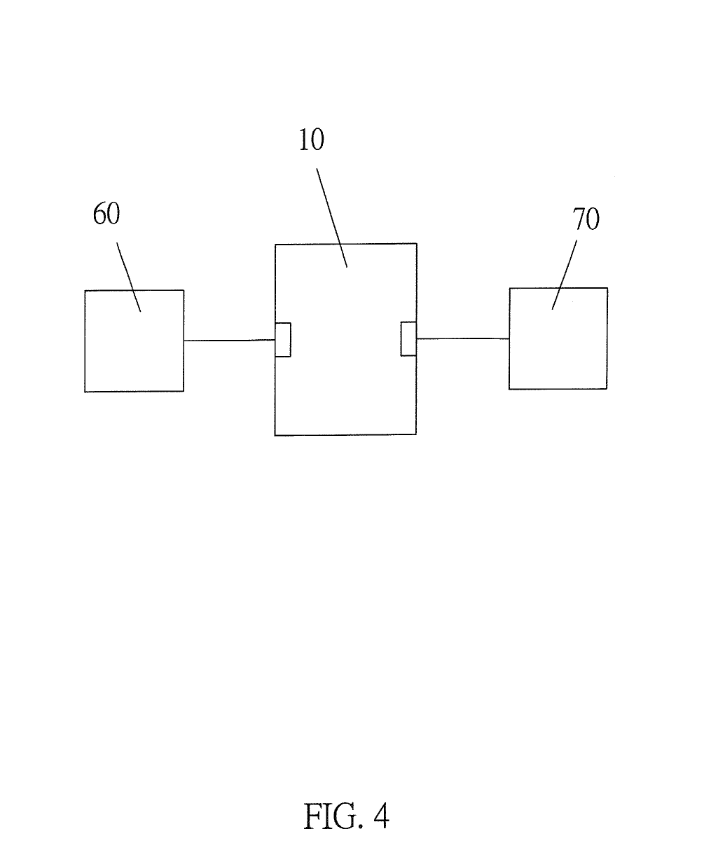

Referring to FIG. 4, the present invention is provided to allow for a power supply device 60 to be electrically connected, through a power transmission cable, to the input port 21. The present invention is also provided to allow the output port 22 to be electrically connected, through a charging cable, to a load 70. Further, with the initial condition of the switching element 30 of the circuit board 20 being an off state and thus not conducting, the situation of instantaneously generating a large current when a positive terminal of the charging cable is put into contact with a negative terminal can be avoided thereby achieving an effect of short-circuit protection of the power supply device 60.

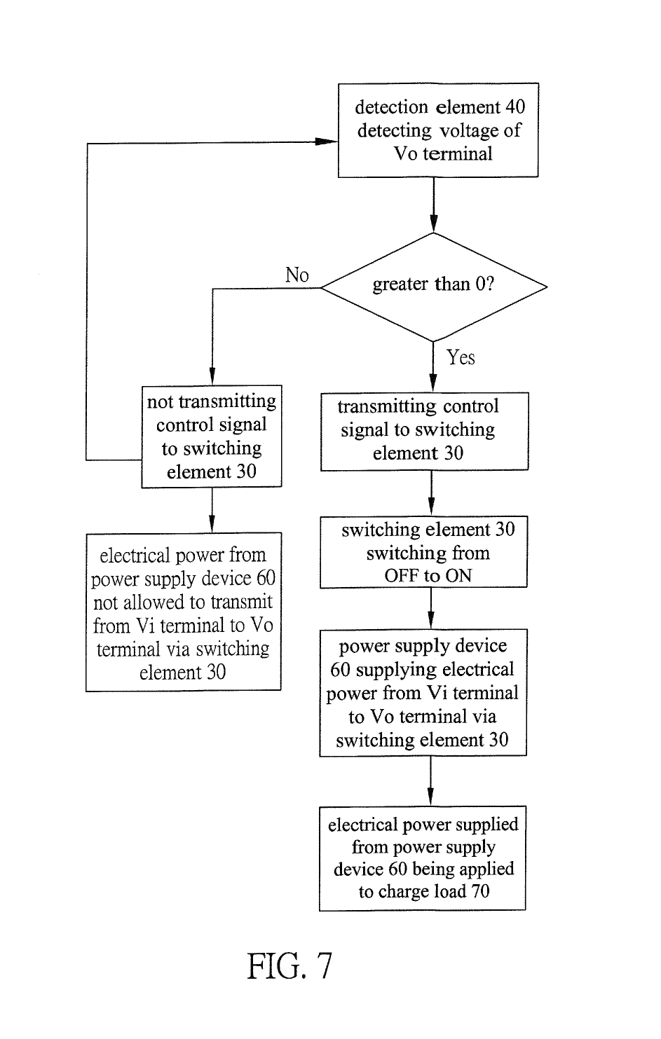

Further, referring to FIGS. 4 and 7, when a Vₒ terminal is connected to a voltage of an external load 70, the detection element 40 of the circuit board 20 immediately detects the Vₒ terminal having a voltage that is greater than 0V and thus immediately transmits a control signal to the switching element 30, making the switching element 30 switch from the OFF state to an ON state of being shorted and conducting, so as to allow the power supply device 60 to supply electrical power through a Vᵢ terminal to the Vₒ terminal to achieve an effect of charging the load 70.

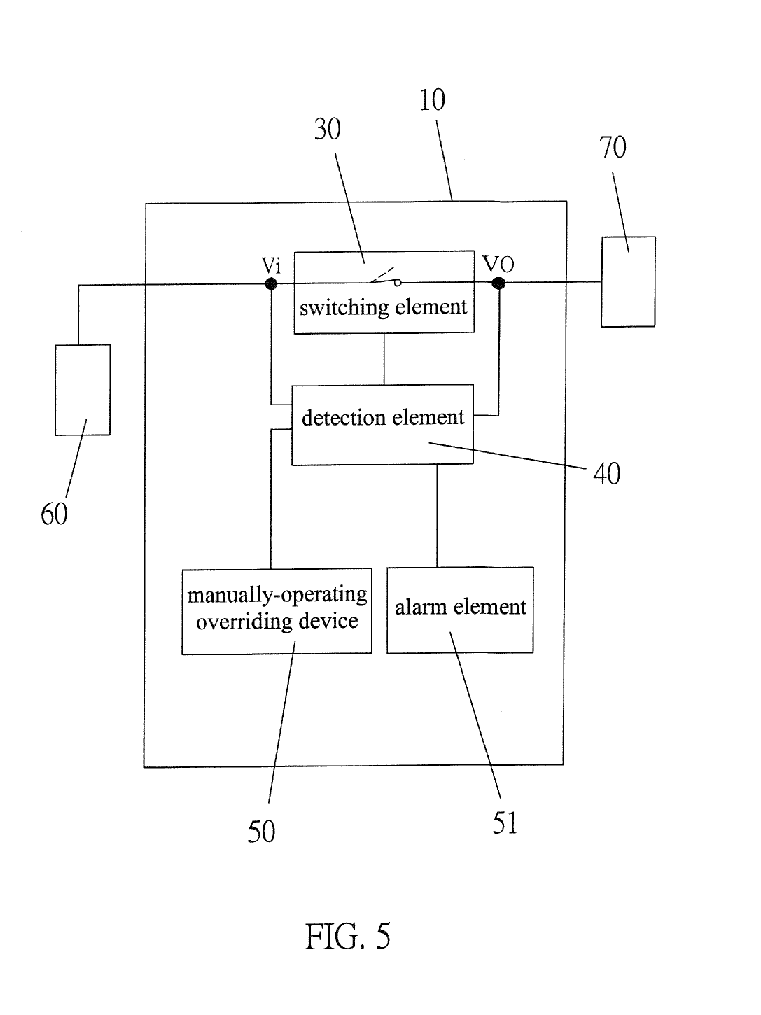

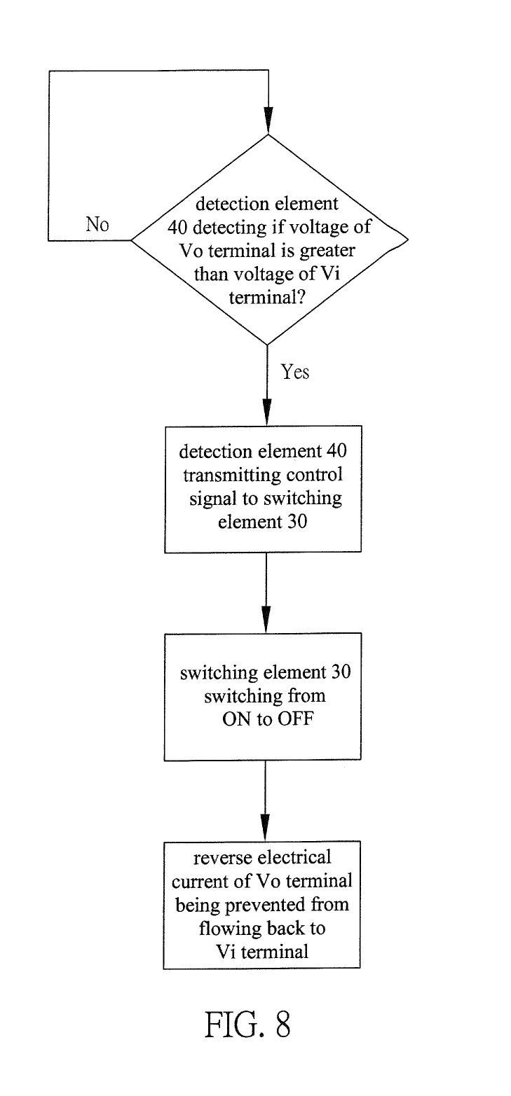

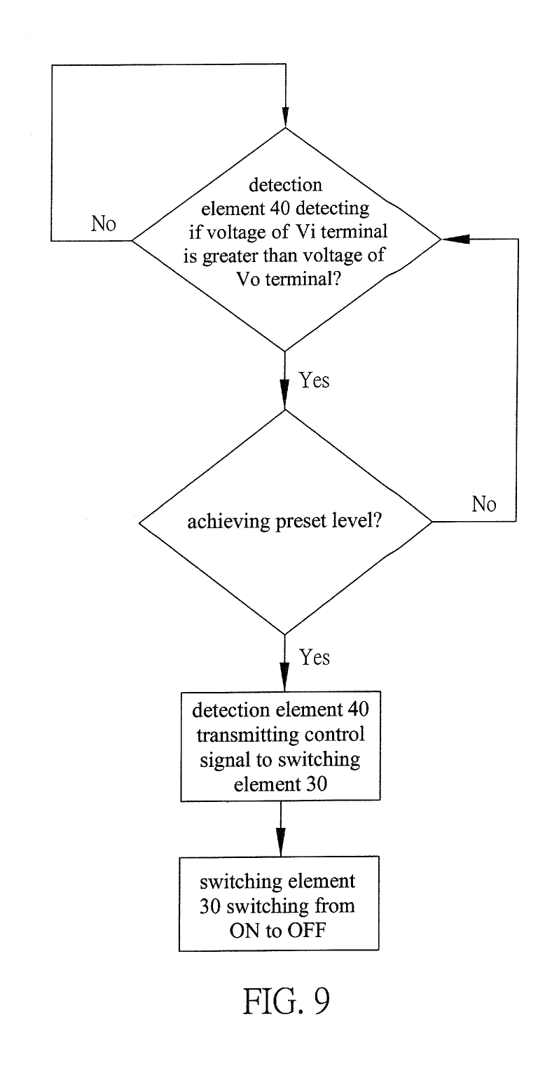

Referring to FIG. 5, the detection element 40 of the circuit board 20 is arranged to do constant detection and recording of variation of voltage between the Vᵢ terminal and the Vₒ terminal or variation of the voltage of the Vₒ terminal itself and to provide an effect of determining if the load 70 is disconnected from the Vₒ terminal according to the variation of voltage between the Vᵢ terminal and the Vₒ terminal or the voltage variation of the Vₒ terminal itself. Thus, when the load 70 is disconnected from the Vₒ terminal, the detection element 40 immediately transmits a control signal to the switching element 30, making the switching element 30 switching from the ON state to the OFF state of being open-circuited and non-conducting, so as to achieve an effect of preventing the power supply device 60 from supplying electrical power from the Vᵢ terminal to the Vₒ terminal and thus achieving an effect of circuit protection. Thus, as shown in FIG. 8, when the detection element 40 detects the voltage of the Vₒ terminal is greater than the voltage of the Vᵢ terminal, the detection element immediately transmits a control signal to the switching element 30, making the switching element 30 switch from the ON state to the OFF state, so that a unidirectional output of electrical current can be accomplished and electrical current is prevented from reversely flowing the Vₒ terminal back to the Vᵢ terminal. Further, as shown in FIG. 9, when the detection element 40 detects the voltage of Vᵢ terminal is greater than the voltage of the Vₒ terminal and achieves a preset level, indicating that the electrical currently flowing from the Vᵢ terminal to the Vₒ terminal reaches a predetermined current value, such a current value being: I=(Vᵢ−Vₒ)÷R (total internal resistance of the switching element), at this moment, the detection element 40 transmits a control signal to the switching element 30, making the switching element 30 switch from the ON state to the OFF state so as to achieve effects of over-current protection and current limiting protection for the output current.

Further, referring to FIG. 5, with the detection element 40 and the output port 22 being electrically connected, when a negative voltage occurs at the output port 22, the detection element 40 identifies that the load 70 or an external battery device (not shown) to which the output port 22 is connected is connected in a manner of the polarities being reversed and thus, the detection element 40 does not transmit a signal to the switching element 30 whereby the switching element 30 maintains in the OFF state and is not conducting. Meanwhile, the detection element 40 immediately transmits a signal to the alarm element 51, making the alarm element 51 giving off an alarm sound, or activating a light-emitting element or a liquid crystal display to provide a reminder to a user of the situation of polarities being reversely connected so as to enhance circuit safety.

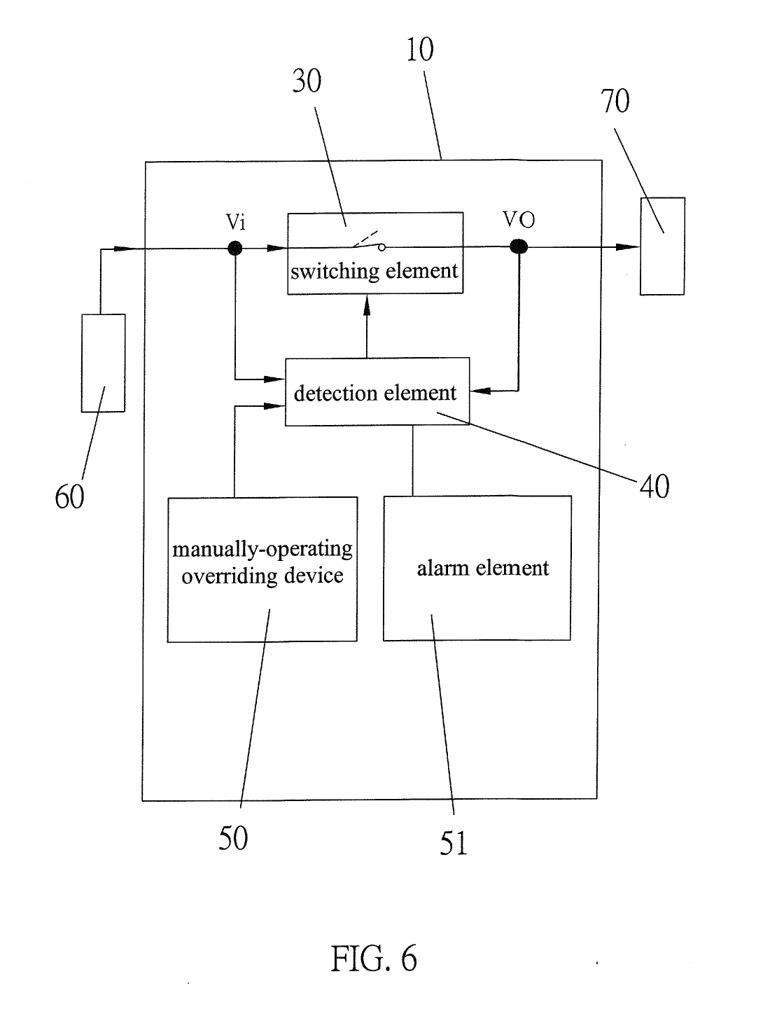

Referring to FIG. 6, the present invention is provided with a manually-operating overriding device 50. When a user is desired to coercively switch the switching element 30 from an OFF state to an ON state, the manually-operating overriding device 50 can be actuated so that the manually-operating overriding device 50 immediately transmits a signal to the detection element 40. The detection element 40, upon receiving the signal, immediately transmits a control signal to the switching element 30, making the switching element 30 switch from the OFF state to the ON. The manually-operating overriding device 50 may be loaded with a preset time limit, whereby after a lapse of time that exceeds the preset time limit, the switching element 30 automatically switches from the ON state back to the OFF state to achieve an effect of circuit protection. Further, when the user actuates the manually-operating overriding device 50, the detection element 40 first detects if a negative voltage is present at the output port 22 and if there is a negative voltage, the transmission of the control signal to the switching element 30 is paused, allowing the switching element 30 to maintain in the OFF state.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multifunctional electrical power output protection device, comprising:
a protection device, wherein the protection device comprises a circuit board mounted therein and the circuit board comprises an input port, an output port, a switching element, a detection element, and a manually-operating overriding device, the manually-operating overriding device being electrically connected to an end of the detection element, the switching element having an end electrically connected to the input port, the switching element having an opposite end electrically connected to the output port, the detection element having an end electrically connected to the input port, the detection element having an opposite end electrically connected to the output port.

2. The multifunctional electrical power output protection device according to claim 1, wherein the switching element has an initial condition of an OFF state, which is open-circuited and is not conducting.

3. The multifunctional electrical power output protection device according to claim 1, wherein the switching element comprises one of a device of a semiconductor manufacturing process and an electro-mechanical device.

4. The multifunctional electrical power output protection device according to claim 1, wherein the switching element comprises one of an FET (Field Effect Transistor), an MOSFET (Metal Oxide Semiconductor Field Effect Transistor), a JFET (Junction Gate Field Effect Transistor), and a relay.

5. The multifunctional electrical power output protection device according to claim 1, wherein the detection element comprises one of a MCU (Microcontroller Unit), a comparator, and an amplifier.

6. The multifunctional electrical power output protection device according to claim 1, wherein the circuit board comprises an alarm element mounted thereon.

7. The multifunctional electrical power output protection device according to claim 2, wherein the circuit board comprises an alarm element mounted thereon.

8. The multifunctional electrical power output protection device according to claim 3, wherein the circuit board comprises an alarm element mounted thereon.

9. The multifunctional electrical power output protection device according to claim 4, wherein the circuit board comprises an alarm element mounted thereon.

10. The multifunctional electrical power output protection device according to claim 5, wherein the circuit board comprises an alarm element mounted thereon.

11. The multifunctional electrical power output protection device according to claim 6, wherein the alarm element comprises one of a buzzer, a light-emitting element, and a liquid crystal display.

12. The multifunctional electrical power output protection device according to claim 7, wherein the alarm element comprises one of a buzzer, a light-emitting element, and a liquid crystal display.

13. The multifunctional electrical power output protection device according to claim 8, wherein the alarm element comprises one of a buzzer, a light-emitting element, and a liquid crystal display.

14. The multifunctional electrical power output protection device according to claim 9, wherein the alarm element comprises one of a buzzer, a light-emitting element, and a liquid crystal display.

15. The multifunctional electrical power output protection device according to claim 10, wherein the alarm element comprises one of a buzzer, a light-emitting element, and a liquid crystal display.
